(19) United States
(12) Patent Application Publication
(10) Pub. No.: US 2025/0371015 A1
(43) Pub. Date: Dec. 4, 2025

(54) Dynamic Selection of Machine-Learning Large Language Models Based on Queries

(71) Applicant: Maplebear Inc., San Francisco, CA (US)

(72) Inventor: Aomin Wu, Scarsdale, NY (US)

(21) Appl. No.: 19/219,883

(22) Filed: May 27, 2025

Related U.S. Application Data
(60) Provisional application No. 63/652,996, filed on May 29, 2024.
(60) Provisional application No. 63/653,749, filed on May 30, 2024.

(51) Int. Cl. G06F 16/2457; G06N 3/084; G06N 3/096

(52) U.S. Cl. CPC G06F 16/24575; G06N 3/084; G06N 3/096

(57) ABSTRACT

An online system receives a user query for execution by at least one of a set of generative artificial intelligence (AI) models. The online system assigns the user query to one or more query categories of a set of query categories. The online system accesses a dataset stored in a database. For each query category, the dataset stores a preferred generative AI model for the query category among the set of generative AI models. The online system selects a preferred generative AI model for the user query from the database based on the one or more query categories assigned to the user query. The online system provides a prompt to a model serving system hosting the selected generative AI model. The online system receives, from the model serving system, a response to the user query generated by executing the prompt.

### CROSS-REFERENCE TO RELATED APPLICATIONS

This application claims the benefit of U.S. Provisional Patent Application No. 63/652,996, filed on May 29, 2024, and U.S. Provisional Patent Application No. 63/653,749, filed on May 30, 2024, all of which are incorporated by reference in their entirety.

### BACKGROUND

An online system may store and manage information on many different types of entities. Often times, users (e.g., application developers) of the online system use generative artificial intelligence (AI) models to perform inference tasks. For example, these may be a set of large language models (LLM's) developed by different entities. The LLM's exhibit distinct characteristics due to variations in their architecture, training data, and training methodologies depending on the entity developing them. These differences result in different models excelling at different tasks.

### SUMMARY

In accordance with one or more aspects of the disclosure, an online system receives, from a client device, a user query for execution by at least one of a set of generative artificial intelligence (AI) models. The online system assigns the user query to one or more query categories of a set of query categories. The online system accesses a dataset stored in a database. For each query category in the set of query categories, the dataset stores a preferred generative AI model for the query category among the set of generative AI models. The online system selects a preferred generative AI model for the user query from the database based on the one or more query categories assigned to the user query. The online system generates a prompt for the selected generative AI model. The prompt includes at least the user query. The online system provides the prompt to a model serving system hosting the selected generative AI model. The online system receives, from the model serving system, a response to the user query generated by executing the prompt. The online system provides the response to the user.

In accordance with one or more aspects of the disclosure, an online system obtains a plurality of queries from users and for each query in the plurality of queries, obtains a respective model deployment selected for the query among a set of model deployments. For each query in the plurality of queries, the online system assigns the query to a respective category among a set of categories by applying one or more machine-learning models to information obtained from the query. The online system generates a dataset stored in a database. In one or more embodiments, for each category in the set of categories, the dataset includes a mapping between the category and a respective model deployment for the category based on one or more queries assigned to the category. The online system receives, from a client device, a user query. The online system assigns the user query to a particular category of the set of categories by applying the one or more machine-learning models to information obtained from the user query. The online system identifies a model deployment mapped to the particular category from the database. The online system provides the user query to the identified model deployment for execution. The online system provides a response obtained from the identified model deployment to the client device as a response to the user query.

### BRIEF DESCRIPTION OF THE DRAWINGS

FIG. 1A illustrates an example system environment for an online system, in accordance with one or more embodiments.

FIG. 1B illustrates an example system environment for an online system, in accordance with one or more embodiments.

FIG. 2 illustrates an example system architecture for an online system, in accordance with one or more embodiments.

FIG. 3A illustrates an example process of creating a model comparison dataset, in accordance with one or more embodiments.

FIG. 3B illustrates an example process of analyzing query-model pairs, in accordance with one or more embodiments.

FIG. 3C illustrates an example process of understanding and classifying queries, in accordance with one or more embodiments.

FIG. 4 illustrates an example process of response generation using a selected model, in accordance with one or more embodiments.

FIG. 5 illustrates the multi-stage evaluation of a chatbot using the accessed conversation, in accordance with one or more embodiments.

FIGS. 6A-6B is a flowchart illustrating a method of dynamically selecting large-scale model deployments, in accordance with one or more embodiments.

FIGS. 7A-7B is a flowchart illustrating a method of multi-stage evaluation for chatbot applications, in accordance with one or more embodiments.

### DETAILED DESCRIPTION

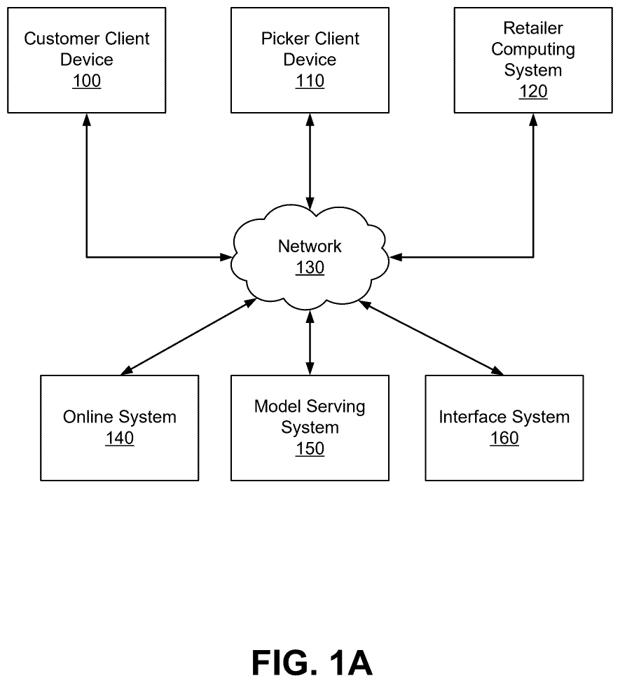

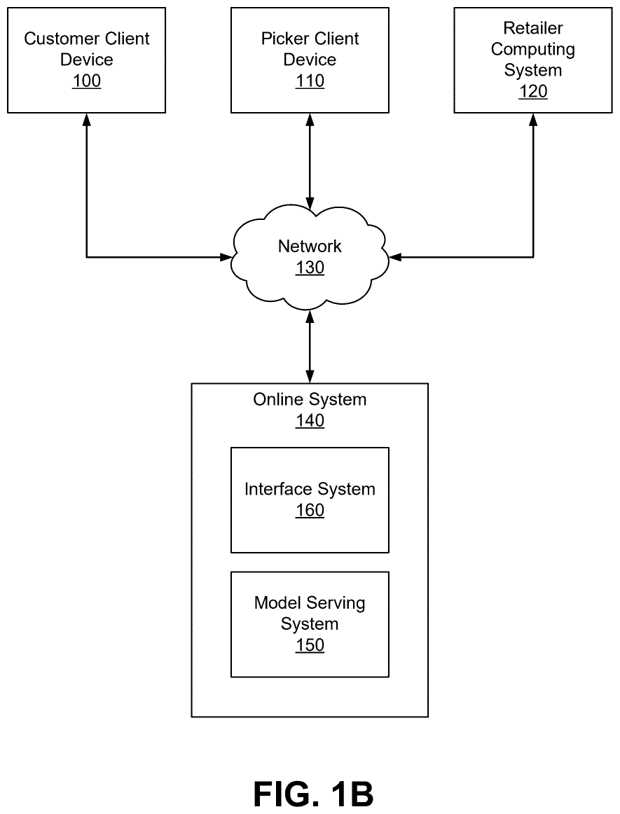

FIG. 1A illustrates an example system environment for an online system 140, in accordance with one or more embodiments. The system environment illustrated in FIG. 1A includes a customer client device 100, a picker client device 110, a retailer computing system 120, a network 130, and an online system 140. Alternative embodiments may include more, fewer, or different components from those illustrated in FIG. 1A, and the functionality of each component may be divided between the components differently from the description below. Additionally, each component may perform their respective functionalities in response to a request from a human, or automatically without human intervention.

As used herein, customers, pickers, and retailers may be generically referred to as “users” of the online system 140. Additionally, while one customer client device 100, picker client device 110, and retailer computing system 120 are illustrated in FIG. 1, any number of customers, pickers, and retailers may interact with the online system 140. As such, there may be more than one customer client device 100, picker client device 110, or retailer computing system 120.

The customer client device 100 is a client device through which a customer may interact with the picker client device 110, the retailer computing system 120, or the online system 140. The customer client device 100 can be a personal or mobile computing device, such as a smartphone, a tablet, a laptop computer, or desktop computer. In some embodiments, the customer client device 100 executes a client application that uses an application programming interface (API) to communicate with the online system 140.

A customer uses the customer client device 100 to place an order with the online system 140. An order specifies a set of items to be delivered to the customer. An “item”, as used herein, means a good or product that can be provided to the customer through the online system 140. The order may include item identifiers (e.g., a stock keeping unit or a price look-up code) for items to be delivered to the user and may include quantities of the items to be delivered. Additionally, an order may further include a delivery location to which the ordered items are to be delivered and a timeframe during which the items should be delivered. In some embodiments, the order also specifies one or more retailers from which the ordered items should be collected.

The customer client device 100 presents an ordering interface to the customer. The ordering interface is a user interface that the customer can use to place an order with the online system 140. In one or more embodiments, the ordering interface may be a part of a client application operating on the customer client device 100. The ordering interface allows the customer to search for items that are available through the online system 140 and the customer can select which items to add to a “shopping list.” A “shopping list,” as used herein, is a tentative set of items that the user has selected for an order but that has not yet been finalized for an order. The ordering interface allows a user to update the shopping list, e.g., by changing the quantity of items, adding or removing items, or adding instructions for items that specify how the item should be collected.

The customer client device 100 may receive additional content from the online system 140 to present to a customer. For example, the customer client device 100 may receive coupons, recipes, or item suggestions. The customer client device 100 may present the received additional content to the customer as the customer uses the customer client device 100 to place an order (e.g., as part of the ordering interface).

Additionally, the customer client device 100 includes a communication interface that allows the customer to communicate with a picker that is servicing the customer's order. This communication interface allows the user to input a text-based message to transmit to the picker client device 110 via the network 130. The picker client device 110 receives the message from the customer client device 100 and presents the message to the picker. The picker client device 110 also includes a communication interface that allows the picker to communicate with the customer. The picker client device 110 transmits a message provided by the picker to the customer client device 100 via the network 130. In some embodiments, messages sent between the customer client device 100 and the picker client device 110 are transmitted through the online system 140. In addition to text messages, the communication interfaces of the customer client device 100 and the picker client device 110 may allow the customer and the picker to communicate through audio or video communications, such as a phone call, a voice-over-IP call, or a video call.

The picker client device 110 is a client device through which a picker may interact with the customer client device 100, the retailer computing system 120, or the online system 140. The picker client device 110 can be a personal or mobile computing device, such as a smartphone, a tablet, a laptop computer, or desktop computer. In some embodiments, the picker client device 110 executes a client application that uses an application programming interface (API) to communicate with the online system 140.

The picker client device 110 receives orders from the online system 140 for the picker to service. A picker services an order by collecting the items listed in the order from a retailer. The picker client device 110 presents the items that are included in the customer's order to the picker in a collection interface. The collection interface is a user interface that provides information to the picker on which items to collect for a customer's order and the quantities of the items. In some embodiments, the collection interface provides multiple orders from multiple customers for the picker to service at the same time from the same retailer location. The collection interface further presents instructions that the customer may have included related to the collection of items in the order. Additionally, the collection interface may present a location of each item in the retailer location, and may even specify a sequence in which the picker should collect the items for improved efficiency in collecting items. In some embodiments, the picker client device 110 transmits to the online system 140 or the customer client device 100 which items the picker has collected in real time as the picker collects the items.

The picker can use the picker client device 110 to keep track of the items that the picker has collected to ensure that the picker collects all of the items for an order. The picker client device 110 may include a barcode scanner that can determine an item identifier encoded in a barcode coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and determines the item identifier for the item based on the images. The picker client device 110 may determine the item identifier directly or by transmitting the images to the online system 140. Furthermore, the picker client device 110 determines a weight for items that are priced by weight. The picker client device 110 may prompt the picker to manually input the weight of an item or may communicate with a weighing system in the retailer location to receive the weight of an item.

When the picker has collected the items for an order, the picker client device 110 instructs a picker on where to deliver the items for a customer's order. For example, the picker client device 110 displays a delivery location from the order to the picker. The picker client device 110 also provides navigation instructions for the picker to travel from the retailer location to the delivery location. Where a picker is servicing more than one order, the picker client device 110 identifies which items should be delivered to which delivery location. The picker client device 110 may provide navigation instructions from the retailer location to each of the delivery locations. The picker client device 110 may receive one or more delivery locations from the online system 140 and may provide the delivery locations to the picker so that the picker can deliver the corresponding one or more orders to those locations. The picker client device 110 may also provide navigation instructions for the picker from the retailer location from which the picker collected the items to the one or more delivery locations.

In one or more embodiments, the picker client device 110 can track the location of the picker as the picker delivers orders to delivery locations. The picker client device 110 collects location data and transmits the location data to the online system 140. The online system 140 may transmit the location data to the customer client device 100 for display to the customer such that the customer can keep track of when their order will be delivered. Additionally, the online system 140 may generate updated navigation instructions for the picker based on the picker's location. For example, if the picker takes a wrong turn while traveling to a delivery location, the online system 140 determines the picker's updated location based on location data from the picker client device 110 and generates updated navigation instructions for the picker based on the updated location.

In one or more embodiments, the picker is a single person who collects items for an order from a retailer location and delivers the order to the delivery location for the order. Alternatively, more than one person may serve the role as a picker for an order. For example, multiple people may collect the items at the retailer location for a single order. Similarly, the person who delivers an order to its delivery location may be different from the person or people who collected the items from the retailer location. In these embodiments, each person may have a picker client device 110 that they can use to interact with the online system 140.

Additionally, while the description herein may primarily refer to picker users as humans, in some embodiments, some or all of the steps taken by the picker may be automated. For example, a semi- or fully-autonomous robot may collect items in a retailer location for an order and an autonomous vehicle may deliver an order to a customer from a retailer location.

The retailer computing system 120 is a computing system operated by a retailer that interacts with the online system 140. As used herein, a “retailer” is an entity that operates a “retailer location,” which is a store, warehouse, or other building from which a picker can collect items. The retailer computing system 120 stores and provides item data to the online system 140 and may regularly update the online system 140 with updated item data. For example, the retailer computing system 120 provides item data indicating which items are available at a retailer location and the quantities of those items. Additionally, the retailer computing system 120 may transmit updated item data to the online system 140 when an item is no longer available at the retailer location. Additionally, the retailer computing system 120 may provide the online system 140 with updated item prices, sales, or availabilities. Additionally, the retailer computing system 120 may receive payment information from the online system 140 for orders serviced by the online system 140. Alternatively, the retailer computing system 120 may provide payment to the online system 140 for some portion of the overall cost of a user's order (e.g., as a commission).

The customer client device 100, the picker client device 110, the retailer computing system 120, and/or the online system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of standard layers used to describe a physical or virtual network, such as the physical layer, the data link layer, the network layer, the transport layer, the session layer, the presentation layer, and the application layer. The network 130 may include physical media for communicating data from one computing device to another computing device, such as MPLS lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online system 140 is an online system by which customers can order items to be provided to them by a picker from a retailer. The online system 140 receives orders from a customer client device 100 through the network 130. The online system 140 selects a picker to service the customer's order and transmits the order to a picker client device 110 associated with the picker. The picker collects the ordered items from a retailer location and delivers the ordered items to the customer. The online system 140 may charge a customer for the order and provide portions of the payment from the customer to the picker and the retailer.

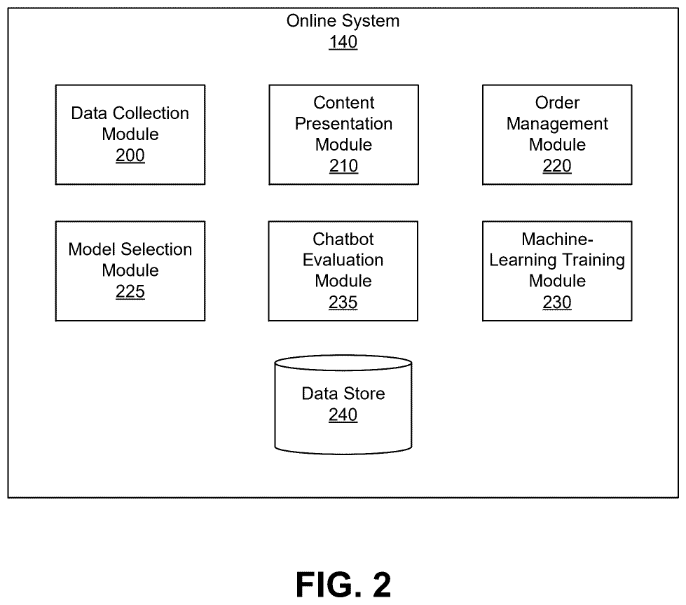

As an example, the online system 140 may allow a customer to order groceries from a grocery store retailer. The customer's order may specify which groceries they want delivered from the grocery store and the quantities of each of the groceries. The customer's client device 100 transmits the customer's order to the online system 140 and the online system 140 selects a picker to travel to the grocery store retailer location to collect the groceries ordered by the customer. Once the picker has collected the groceries ordered by the customer, the picker delivers the groceries to a location transmitted to the picker client device 110 by the online system 140. The online system 140 is described in further detail below with regards to FIG. 2.

The model serving system 150 receives requests from the online system 140 to perform tasks using machine-learning models. The tasks include, but are not limited to, natural language processing (NLP) tasks, audio processing tasks, image processing tasks, video processing tasks, and the like. In one or more embodiments, the machine-learning models deployed by the model serving system 150 are models configured to perform one or more NLP tasks. The NLP tasks include, but are not limited to, text generation, query processing, machine translation, chatbots, and the like. In one or more embodiments, the language model is configured as a transformer neural network architecture. Specifically, the transformer model is coupled to receive sequential data tokenized into a sequence of input tokens and generates a sequence of output tokens depending on the task to be performed.

The model serving system 150 receives a request including input data (e.g., text data, audio data, image data, or video data) and encodes the input data into a set of input tokens. The model serving system 150 applies the machine-learning model to generate a set of output tokens. Each token in the set of input tokens or the set of output tokens may correspond to a text unit. For example, a token may correspond to a word, a punctuation symbol, a space, a phrase, a paragraph, and the like. For an example query processing task, the language model may receive a sequence of input tokens that represent a query and generate a sequence of output tokens that represent a response to the query. For a translation task, the transformer model may receive a sequence of input tokens that represent a paragraph in German and generate a sequence of output tokens that represents a translation of the paragraph or sentence in English. For a text generation task, the transformer model may receive a prompt and continue the conversation or expand on the given prompt in human-like text.

When the machine-learning model is a language model, the sequence of input tokens or output tokens are arranged as a tensor with one or more dimensions, for example, one dimension, two dimensions, or three dimensions. For example, one dimension of the tensor may represent the number of tokens (e.g., length of a sentence), one dimension of the tensor may represent a sample number in a batch of input data that is processed together, and one dimension of the tensor may represent a space in an embedding space. However, it is appreciated that in other embodiments, the input data or the output data may be configured as any number of appropriate dimensions depending on whether the data is in the form of image data, video data, audio data, and the like. For example, for three-dimensional image data, the input data may be a series of pixel values arranged along a first dimension and a second dimension, and further arranged along a third dimension corresponding to RGB channels of the pixels.

In one or more embodiments, the language models are large language models (LLMs) that are trained on a large corpus of training data to generate outputs for the NLP tasks. An LLM may be trained on massive amounts of text data, often involving billions of words or text units. The large amount of training data from various data sources allows the LLM to generate outputs for many tasks. An LLM may have a significant number of parameters in a deep neural network (e.g., transformer architecture), for example, at least 1 billion, at least 15 billion, at least 135 billion, at least 175 billion, at least 500 billion, at least 1 trillion, at least 1.5 trillion parameters.

Since an LLM has significant parameter size and the amount of computational power for inference or training the LLM is high, the LLM may be deployed on an infrastructure configured with, for example, supercomputers that provide enhanced computing capability (e.g., graphic processor units) for training or deploying deep neural network models. In one instance, the LLM may be trained and deployed or hosted on a cloud infrastructure service. The LLM may be pre-trained by the online system 140 or one or more entities different from the online system 140. An LLM may be trained on a large amount of data from various data sources. For example, the data sources include websites, articles, posts on the web, and the like. From this massive amount of data coupled with the computing power of LLM's, the LLM is able to perform various tasks and synthesize and formulate output responses based on information extracted from the training data.

In one or more embodiments, when the machine-learning model including the LLM is a transformer-based architecture, the transformer has a generative pre-training (GPT) architecture including a set of decoders that each perform one or more operations to input data to the respective decoder. A decoder may include an attention operation that generates keys, queries, and values from the input data to the decoder to generate an attention output. In another embodiment, the transformer architecture may have an encoder-decoder architecture and includes a set of encoders coupled to a set of decoders. An encoder or decoder may include one or more attention operations.

While a LLM with a transformer-based architecture is described as a primary embodiment, it is appreciated that in other embodiments, the language model can be configured as any other appropriate architecture including, but not limited to, long short-term memory (LSTM) networks, Markov networks, BART, generative-adversarial networks (GAN), diffusion models (e.g., Diffusion-LM), and the like.

In one or more embodiments, the task for the model serving system 150 is based on knowledge of the online system 140 that is fed to the machine-learning model of the model serving system 150, rather than relying on general knowledge encoded in the model weights of the model. Thus, one objective may be to perform various types of queries on the external data in order to perform any task that the machine-learning model of the model serving system 150 could perform. For example, the task may be to perform question-answering, text summarization, text generation, and the like based on information contained in an external dataset.

Thus, in one or more embodiments, the online system 140 is connected to an interface system 160. The interface system 160 receives external data from the online system 140 and builds a structured index over the external data using, for example, another model or heuristics. The interface system 160 receives one or more queries from the online system 140 on the external data. The interface system 160 constructs one or more prompts for input to the model serving system 150. A prompt may include the query of the user and context obtained from the structured index of the external data. In one instance, the context in the prompt includes portions of the structured indices as contextual information for the query. The interface system 160 obtains one or more responses from the model serving system 160 and synthesizes a response to the query on the external data. While the online system 140 can generate a prompt using the external data as context, often times, the amount of information in the external data exceeds prompt size limitations configured by the machine-learning language model. The interface system 160 can resolve prompt size limitations by generating a structured index of the data and offers data connectors to external data sources.

FIG. 1B illustrates an example system environment for an online system 140, in accordance with one or more embodiments. The system environment illustrated in FIG. 1B includes a customer client device 100, a picker client device 110, a retailer computing system 120, a network 130, and an online system 140. Alternative embodiments may include more, fewer, or different components from those illustrated in FIG. 1B, and the functionality of each component may be divided between the components differently from the description below. Additionally, each component may perform their respective functionalities in response to a request from a human, or automatically without human intervention.

The example system environment in FIG. 1A illustrates an environment where the model serving system 150 and/or the interface system 160 is managed by a separate entity from the online system 140. In one or more embodiments, as illustrated in the example system environment in FIG. 1B, the model serving system 150 and/or the interface system 160 is managed and deployed by the entity managing the online system 140.

FIG. 2 illustrates an example system architecture for an online system 140, in accordance with some embodiments. The system architecture illustrated in FIG. 2 includes a data collection module 200, a content presentation module 210, an order management module 220, a model selection module 225, a machine-learning training module 230, a chatbot evaluation module 235, and a data store 240. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online system 140 and stores the data in the data store 240. The data collection module 200 may only collect data describing a user if the user has previously explicitly consented to the online system 140 collecting data describing the user. Additionally, the data collection module 200 may encrypt all data, including sensitive or personal data, describing users.

For example, the data collection module 200 collects customer data, which is information or data that describe characteristics of a customer. Customer data may include a customer's name, address, shopping preferences, favorite items, or stored payment instruments. The customer data also may include default settings established by the customer, such as a default retailer/retailer location, payment instrument, delivery location, or delivery timeframe. The data collection module 200 may collect the customer data from sensors on the customer client device 100 or based on the customer's interactions with the online system 140.

The data collection module 200 also collects item data, which is information or data that identifies and describes items that are available at a retailer location. The item data may include item identifiers for items that are available and may include quantities of items associated with each item identifier. Additionally, item data may also include attributes of items such as the size, color, weight, stock keeping unit (SKU), or serial number for the item. The item data may further include purchasing rules associated with each item, if they exist. For example, age-restricted items such as alcohol and tobacco are flagged accordingly in the item data. Item data may also include information that is useful for predicting the availability of items in retailer locations. For example, for each item-retailer combination (a particular item at a particular warehouse), the item data may include a time that the item was last found, a time that the item was last not found (a picker looked for the item but could not find it), the rate at which the item is found, or the popularity of the item. The data collection module 200 may collect item data from a retailer computing system 120, a picker client device 110, or the customer client device 100.

An item category is a set of items that are a similar type of item. Items in an item category may be considered to be equivalent to each other or that may be replacements for each other in an order. For example, different brands of sourdough bread may be different items, but these items may be in a “sourdough bread” item category. The item categories may be human-generated and human-populated with items. The item categories also may be generated automatically by the online system 140 (e.g., using a clustering algorithm).

The data collection module 200 also collects picker data, which is information or data that describes characteristics of pickers. For example, the picker data for a picker may include the picker's name, the picker's location, how often the picker has services orders for the online system 140, a customer rating for the picker, which retailers the picker has collected items at, or the picker's previous shopping history. Additionally, the picker data may include preferences expressed by the picker, such as their preferred retailers to collect items at, how far they are willing to travel to deliver items to a customer, how many items they are willing to collect at a time, timeframes within which the picker is willing to service orders, or payment information by which the picker is to be paid for servicing orders (e.g., a bank account). The data collection module 200 collects picker data from sensors of the picker client device 110 or from the picker's interactions with the online system 140.

Additionally, the data collection module 200 collects order data, which is information or data that describes characteristics of an order for a user. For example, order data may include item data for items that are included in the order, a delivery location for the order, a customer associated with the order, a retailer location from which the customer wants the ordered items collected, or a timeframe within which the customer wants the order delivered. Order data may further include information describing how the order was serviced, such as which picker serviced the order, when the order was delivered, or a rating that the customer gave the delivery of the order. In some embodiments, the order data includes user data for users associated with the order, such as customer data for a customer who placed the order or picker data for a picker who serviced the order.

The content presentation module 210 selects content for presentation to a customer. For example, the content presentation module 210 selects which items to present to a customer while the customer is placing an order. The content presentation module 210 generates and transmits the ordering interface for the customer to order items. The content presentation module 210 populates the ordering interface with items that the customer may select for adding to their order. In some embodiments, the content presentation module 210 presents a catalog of all items that are available to the customer, which the customer can browse to select items to order. The content presentation module 210 also may identify items that the customer is most likely to order and present those items to the customer. As an example, the content presentation module 210 may score items and rank the items based on their scores. The content presentation module 210 displays the items with scores that exceed some threshold (e.g., the top n items or the p percentile of items).

The content presentation module 210 may use an item selection model to score items for presentation to a customer. An item selection model is a machine-learning model that is trained to score items for a customer based on item data for the items and customer data for the customer. For example, the item selection model may be trained to determine a likelihood that the customer will order the item. In some embodiments, the item selection model uses item embeddings describing items and customer embeddings describing customers to score items. These item embeddings and customer embeddings may be generated by separate machine-learning models and may be stored in the data store 240.

In some embodiments, the content presentation module 210 scores items based on a search query received from the customer client device 100. A search query is free text for a word or set of words that indicate items of interest to the customer. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a customer (e.g., by comparing a search query embedding to an item embedding).

In some embodiments, the content presentation module 210 scores items based on a predicted availability of an item. The content presentation module 210 may use an availability model to predict the availability of an item. An availability model is a machine-learning model that is trained to predict the availability of an item at a retailer location. For example, the availability model may be trained to predict a likelihood that an item is available at a retailer location or may predict an estimated number of items that are available at a retailer location. The content presentation module 210 may weight the score for an item based on the predicted availability of the item. Alternatively, the content presentation module 210 may filter out items from presentation to a customer based on whether the predicted availability of the item exceeds a threshold.

In one or more embodiments, given the content presentation module 210 receives one or more recommendations from the recommendation module 235 that were identified via a knowledge graph constructed by the knowledge graph module 225. The content presentation module 210 may present the items that were recommended by the recommendation module 235 to the user, such that the user can consider purchase of those items.

The order management module 220 that manages orders for items from customers. The order management module 220 receives orders from a customer client device 100 and offers the orders to pickers for service based on picker data. For example, the order management module 220 offers an order to a picker based on the picker's location and the location of the retailer from which the ordered items are to be collected. The order management module 220 may also offers an order to a picker based on how many items are in the order, a vehicle operated by the picker, the delivery location, the picker's preferences on how far to travel to deliver an order, the picker's ratings by customers, or how often a picker agrees to service an order.

In some embodiments, the order management module 220 determines when to offer an order to a picker based on a delivery timeframe requested by the customer with the order. The order management module 220 computes an estimated amount of time that it would take for a picker to collect the items for an order and deliver the ordered item to the delivery location for the order. The order management module 220 offers the order to a picker at a time such that, if the picker immediately services the order, the picker is likely to deliver the order at a time within the timeframe. Thus, when the order management module 220 receives an order, the order management module 220 may delay in offering the order to a picker if the timeframe is far enough in the future.

When the order management module 220 offers an order to a picker, the order management module 220 transmits the order to the picker client device 110 associated with the picker. The order management module 220 may also transmit navigation instructions from the picker's current location to the retailer location associated with the order. If the order includes items to collect from multiple retailer locations, the order management module 220 identifies the retailer locations to the picker and may also specify a sequence in which the picker should visit the retailer locations.

The order management module 220 may track the location of the picker user through the picker client device 110 to determine when the picker arrives at the retailer location. When the picker arrives at the retailer location, the order management module 220 transmits the order to the picker client device 110 for display to the picker. As the picker uses the picker client device 110 to collect items at the retailer location, the order management module 220 receives item identifiers for items that the picker has collected for the order. In one or more embodiments, the order management module 220 receives images of items from the picker client device 110 and applies computer-vision techniques to the images to identify the items depicted by the images. The order management module 220 may track the progress of the picker user as the picker collects items for an order and may transmit progress updates to the customer client device 100 that describe which items have been collected for the customer's order.

In some embodiments, the order management module 220 tracks the location of the picker within the retailer location. The order management module 220 uses sensor data from the picker client device 110 or from sensors in the retailer location to determine the location of the picker in the retailer location. The order management module 220 may transmit to the picker client device 110 instructions to display a map of the retailer location indicating where in the retailer location the picker is located. Additionally, the order management module 220 may instruct the picker client device 110 to display the locations of items for the picker to collect, and may further display navigation instructions for how the picker can travel from their current location to the location of a next item to collect for an order.

The order management module 220 determines when the picker has collected all of the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the retailer location to the delivery location, or to a subsequent retailer location for further item collection. The order management module 220 tracks the location of the picker as the picker travels to the delivery location for an order, and updates the customer with the location of the picker so that the customer can track the progress of their order. In some embodiments, the order management module 220 computes an estimated time of arrival for the picker at the delivery location and provides the estimated time of arrival to the customer.

In some embodiments, the order management module 220 facilitates communication between the customer client device 100 and the picker client device 110. As noted above, a customer may use a customer client device 100 to send a message to the picker client device 110. The order management module 220 receives the message from the customer client device 100 and transmits the message to the picker client device 110 for presentation to the picker. The picker may use the picker client device 110 to send a message to the customer client device 100 in a similar manner.

The order management module 220 coordinates payment by the customer for the order. The order management module 220 uses payment information provided by the customer (e.g., a credit card number or a bank account) to receive payment for the order. In some embodiments, the order management module 220 stores the payment information for use in subsequent orders by the customer. The order management module 220 computes a total cost for the order and charges the customer that cost. The order management module 220 may provide a portion of the total cost to the picker for servicing the order, and another portion of the total cost to the retailer.

### 1. Dynamic Selection of Large Language Models (LLMs)

The model selection module 225 analyzes user queries obtained from the users of the online system 140 to categorize the user queries, and identifies a preferred AI model for each respective category based on responses obtained for one or more user queries associated with each respective category. The model selection module 225 selects a generative AI model (e.g., LLM) for a given task, based on the relative strengths and performance characteristics of various models.

Often times, users (e.g., application developers or customer users) of the online system 140 use generative AI models to perform various inference tasks. For example, these may be a set of large language models (LLM's) developed by different entities within the online system 140 or a set of LLM's trained with different sets of training data, and the like. The LLM's exhibit distinct characteristics due to variations in their architecture, training data, and training methodologies depending on the entity developing them. These differences result in different models excelling at different tasks. For example, a first image generation model may outperform a second image generation model in recognizing size measurements in product attributes, while the latter may be superior in identifying the quantity of items in a package. As another example, in coding applications, developers often manually select the best response from multiple models, which is time-consuming and wasteful. Moreover, redundant computational resources are wasted as responses are generated for the same query multiple times.

The model selection module 225 includes one or more components for efficiently analyzing queries and routing queries to the best-performing model, therefore improving response quality and reducing computational costs. The first component is a component for creating a dataset that records performance comparisons between different models. The model selection module 225 collects responses from multiple models (e.g., multiple LLM's) to identical or substantially similar queries, recording which model's response was preferred by users. The model selection module 225 builds a dataset correlating the queries to the preferred model that was selected for the query.

In one or more instances, the preferred response is identified by presenting multiple responses from the different generative AI models and allowing a user of the query to click on the preferred response. For example, the online system 140 may generate a user interface (UI) on a client device 100 with responses from the set of AI models in one or more interactable UI elements, so that the user can select the UI element displaying the preferred response. In other instances, the preferred response is identified by determining a user copy-pasted a response from the interface of a given model, therefore indicating that the user preferred and used the response from that model. Therefore, the dataset records mappings between a query and the response from a preferred model by the user.

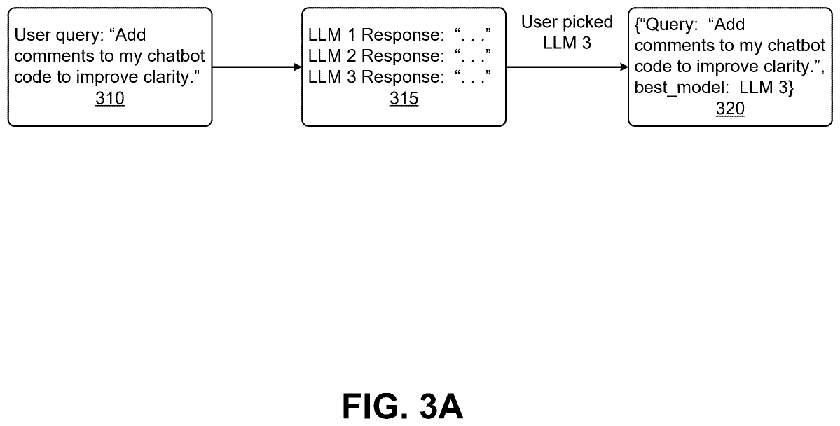

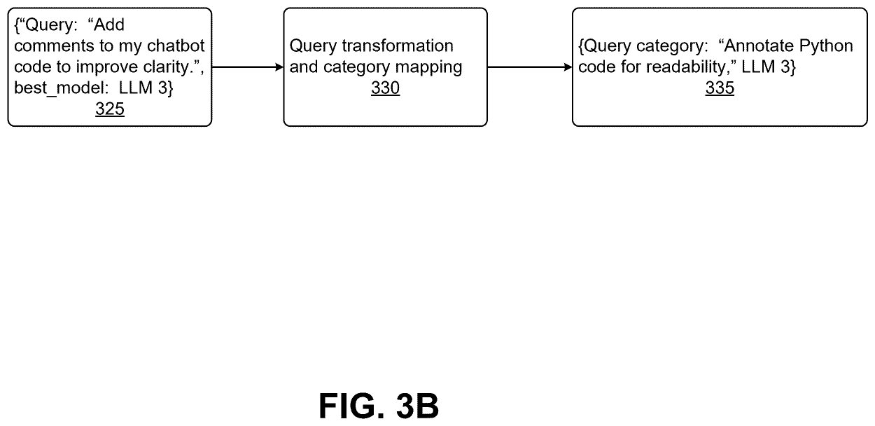

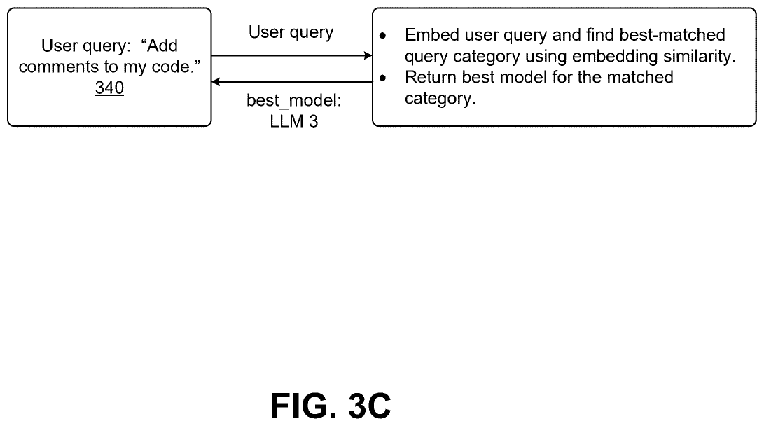

FIG. 3A illustrates an example process of creating a model comparison dataset, in accordance with one or more embodiments. As shown in FIG. 3A, a user may have submitted a query 310 “[a]dd comments to my chatbot code to improve clarity.” to three LLM deployments, which are labeled LLM 1, LLM 2, and LLM 3. The user receives responses 315 from each of the LLM's. The user selects the response from LLM 3 as the preferred response. The model selection module 225 records an instance 320 in the dataset that indicates contents of the query and the selected model pairing. The model selection module 225 may repeat this process for different instances of user queries to create the dataset.

The model selection module 225 includes a second component that is an analytics engine. The model selection module 225 via the analytics engine analyzes query-model pairs. The model selection module 225 categorizes the queries into generalized query types or categories. Specifically, since the queries may be natural language queries and are open-ended statements, the analytics engine maps the queries into a set of finite categories. In one or more embodiments, the model selection module 225 employs a categorization LLM or a machine-learning categorization model (e.g., classification model classifying a category into one among 20 categories) to assist in abstracting specific queries into broader and/or general categories for use. The categorization model is coupled to receive at least a query and generate a category assigned to the query.

In one or more embodiments, the categorization model is coupled to receive information obtained from a query as input, and output an estimated category the query should be assigned to. In one or more embodiments, the model selection module 225 trains an embedding model as a component of the categorization model that is coupled to receive text or images and generates an embedding for the text or images in a latent space (e.g., vector). Thus, the query is mapped to a query embedding and the different categories are each mapped to a respective category embedding. The model selection module 225 may select a category for the query having a category embedding that is within a threshold distance with the query embedding, as measured by the absolute difference (e.g., L1 norm or L2 norm) between the query embedding and the categorization embedding.

As an example in FIG. 3B, the categorization model may retrieve a set of queries 325 from the dataset, for example, including both a first query “[a] dd comments to my chatbot code to improve clarity.” and a second query “[i]mprove my Python code to make it easier to follow.” The model selection module 225 performs a query transformation and category mapping process 330 and maps both example queries to the same query category “annotate Python code for readability.” As another example, there may be other categories such as query category “extract attributes from item image,” “respond to e-commerce related questions,” and the like.

In one or more embodiments, the model selection module 225 may create the set of categories based on feedback from a human operator. In other instances, the model selection module 225 may prompt an LLM to create an initial set of categories that is reviewed by a human operator. Moreover, the model selection module 225 may receive positive or negative feedback from users for a given query-categorization classification. For example, later during serving, when a model selected by the model selection module 225 receives positive feedback from a user (e.g., user uses the response), the model selection module 225 may fine-tune parameters of the categorization model using these positive instances (or negative instances).

In one or more embodiments, the process of creating the set of categories is iteratively refined to create even more granular levels of categories as additional feedback data is received from users of the online system 140. At first, a relatively broader set of categories are created, and a broad category may be further subdivided into sub-categories per domain, sub-categories per model type, and the like. For example, returning to the example category of “annotate Python code for readability,” the example category can be further divided into sub-categories for different domains, a first sub-category for “annotate Python code for training machine-learning models” and a second sub-category for “annotate Python code for database development.” As yet another example, the first sub-category may be further divided into a third sub-category for “annotate Python code for training image generation models” and a fourth sub-category for “annotate Python code for training text generation models.”

This way, the queries and preferred models stored in the model comparison dataset includes a mapping for not only a query to a preferred model, but also the category assigned to the query. In the example of FIG. 3B, the dataset includes a mapping 335 between the category “[a]nnotate Python code for readability” to a preferred LLM, LLM 3. In one or more instances, the preferred generative AI model for a category is selected by reviewing which models are selected as the preferred models for queries that are assigned to the category. The model selection module 225 may select the preferred model that was selected for a majority of the queries associated with the category. As an example, the model comparison dataset may have 85% of queries assigned to this category with a preferred model of LLM 3, and therefore, may select LLM 3 as the preferred model for the category.

The model selection module 225 includes a third component for serving. The serving component receives a user query (e.g., a query that was not seen before in the model comparison dataset) and assigns the query to a respective category. The model selection module 225 applies the categorization model to the user query to assign the query to the respective category. The model selection module 225 retrieves one or more of the preferred models for the category and provides the query to the preferred model deployment to obtain a response to the query.

FIG. 3C illustrates an example process of classifying queries, in accordance with one or more embodiments. As shown in FIG. 3C, the user submits a new query 340 “add comments to my code.” The text for the query is input to the embedding model to generate a query embedding. The query embedding is used to select one or more categories. The example query is assigned to the category of “[a] nnotate Python code for readability.” For the selected category, the preferred model (e.g., as indicated by percentage of instances in model comparison dataset) is retrieved from the dataset.

The model selection module 225 routes the user query to the selected model using, for example, an application programming interface (API) call or another remote procedure call (RPC). The model selection module 225 receives a response from the selected model after executing the prompt including the query. The model selection module 225 returns a response to the user of the query.

In one or more embodiments, for a same query category, there may be differences in preferences of users for the generative AI models. For example, for a query category “respond to general e-commerce questions,” certain users may prefer one model over another. For example, a first set of users may prefer LLM 2, and another second set of users may prefer LLM 1. Therefore, the model selection module 225 may also generate different user personas and assign different preferred models depending on the query category. Therefore, when a user assigned to a certain persona submits the query of the particular query category, the preferred model for that query category and the user persona is retrieved.

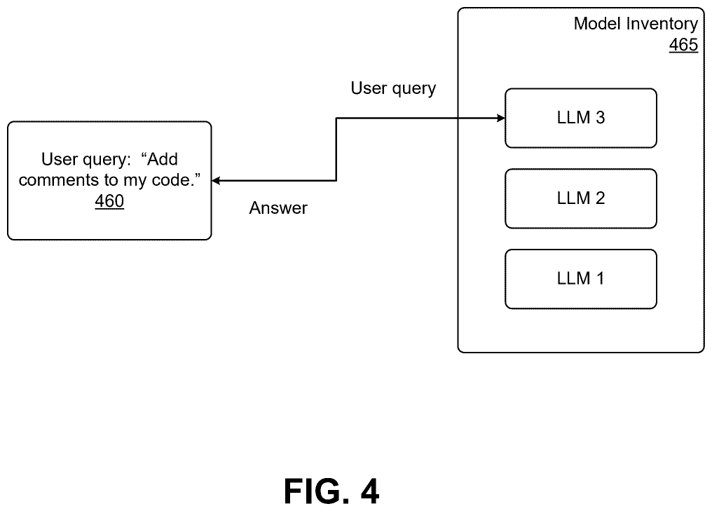

FIG. 4 illustrates an example process of response generation using the selected model, in accordance with one or more embodiments. The model selection module 225 provides the user query to the selected LLM, LLM 3. The model selection module 225 retrieves a response to the query and provides the response to the user. The classification enables the model selection module 225 to route each query to the best-performing model or preferred model for its category. By analyzing and tracking performance of different generative AI models and their categories, the model selection module 225 can efficiently route queries to the best-performing or preferred model, improving response quality and reducing computational costs.

### 2. Large-Language Model Based Multi-Dimensional Chatbot Evaluation System

Online systems are increasingly using messaging systems or chatbot systems to provide customer service and support. However, evaluating the effectiveness and accuracy of a chatbot application can be challenging. In one or more embodiments, the online system 140 can evaluate LLMs to score an individual conversation as a whole, without providing insight into the inner workings of the chatbot. This makes it difficult to identify the root cause of problems and to make targeted improvements of the chatbot. For example, if a chatbot provides an incorrect answer, it's unclear whether this is due to the chatbot relying on the wrong retrieved documents or failing to extract the correct answer from the appropriate documents.

Returning to FIG. 2, the chatbot evaluation module 235 employs machine-learning models to evaluate the quality and accuracy at an overall conversation level, by examining the underlying processes and the intermediate steps that lead to the messaging system's responses. The chatbot evaluation module 235 analyzes both the final conversation and the steps involved in decision-making and data retrieval. This provides comprehensive insights, facilitates quick identification, and resolves issues to improve product performance. The chatbot evaluation module 235 accesses a chatbot application between a user and the online system 140.

The chatbot evaluation module 235 obtains as input both the chatbot conversation and the intermediate parameters produced to generate each single turn response (e.g., parameters for API calls, or retrieved documents). The chatbot evaluation module 235 obtains a conversation between the chatbot application and a user of the online system 140. In one or more embodiments, the chatbot evaluation module 235 has access to or communicates with a LLM to perform multi-stage evaluation.

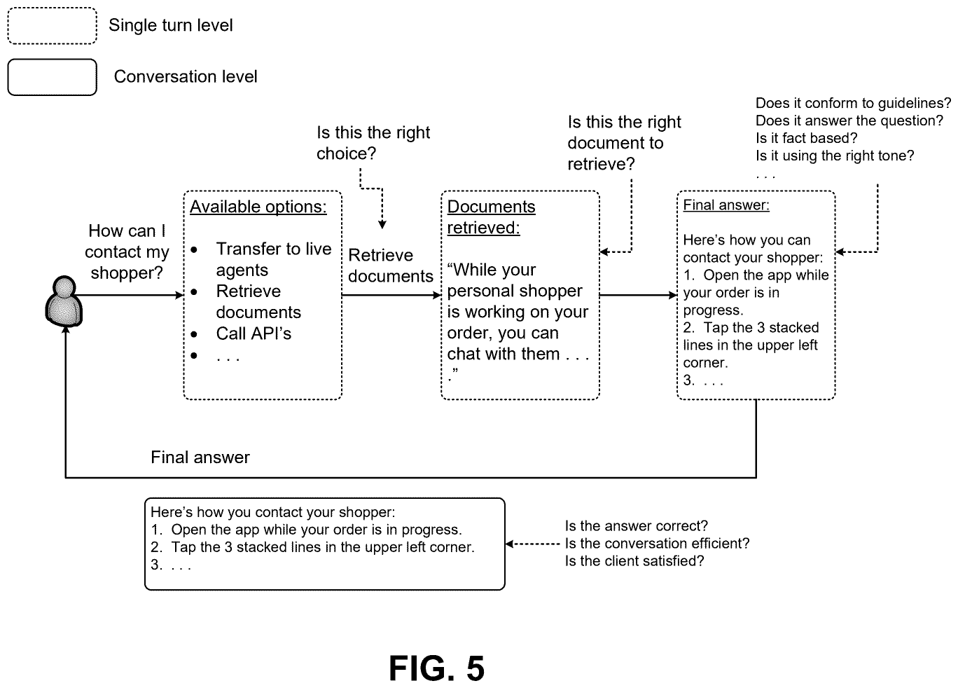

FIG. 5 illustrates the multi-stage evaluation of a chatbot application using the accessed conversation, in accordance with one or more embodiments. At a first stage, the decision stage, the chatbot evaluation module 235 prompts the LLM with a set of decisions the chatbot application can take, and the conversation to confirm that the selected decision is correct. In one or more embodiments, a set of received decisions corresponds to a single turn response from the chatbot application to generate a response (e.g., transferring to live agents, invoking an API, retrieving a document, or providing a simple response to the user).

The chatbot evaluation module 225 receives a response from the language model of the determined decision and confirms that the decision from the LLM is correct. The response may be a numerical evaluation score to confirm the degree of the decision from the chatbot application is correct. An example of a prompt to the LLM to generate an evaluation score is “[t]he user asked to cancel an order. The chatbot decided to call the CancellationAPI. Evaluate whether this decision was appropriate and score it on a scale of 1 to 10.” The response could be an 8 which indicates an appropriate decision based on the user's request.

At a second stage, the intermediate parameter stage, the chatbot evaluation module 235 prompts the LLM to confirm the parameters of the determined decision. The chatbot evaluation module 235 receives a response from the LLM including the confirmed parameters of the determined decision and/or the retrieved documents. For example, if the confirmed decision is an API call, then the evaluation at the second stage may be to confirm parameters by confirming whether the API call parameters are correct. As yet another example, if the confirmed decision is to retrieve documents, then the evaluation at the second stage may be to confirm that the retrieved documents are relevant to the question in the conversation.

Returning to the example in FIG. 5, the confirmed decision is one or more retrieved documents, and one of the retrieved documents contains “[w]hile your personal shopper is working on your order, you can chat with them.” Similar to the first stage, the evaluation could be an evaluation score at the intermediate parameter stage. The chatbot evaluation module 235 prompts the LLM to evaluate whether the retrieved document is relevant to responding to the user query. For example, the LLM may assign a score of 9, indicating that the retrieved document was relevant to answering the user's query.

At a third stage, the generation stage, the chatbot evaluation module 235 prompts the LLM to confirm that the generated response conforms to a set of received guidelines. An example of a set of received guidelines is “does it answer the question?”, “is it fact based?”, or “is it using the right tone?”. Returning to the example in FIG. 5, the chatbot evaluation module 235 obtains a final answer generated by the chatbot application with instructions on how to contact a shopper. The chatbot evaluation module 235 receives a response from the LLM that confirms whether the generated response conforms to the set of received guidelines. Similar to the first stage, at the generation stage, the evaluation could be an evaluation score. For example, the score may be 7, indicating that the response generally conformed to the guidelines and it formulated the answer based on the retrieved document.

At a fourth stage, the chatbot evaluation module 235 prompts the LLM to confirm that the generated answer is communicated to the user effectively. The chatbot evaluation module 235 determines whether the final response is correct, communicated to the user effectively, and whether the user is satisfied with the response. The chatbot evaluation module 235 receives a response from the LLM confirming whether the final response is effectively communicated to the user.

An overall chat score is an aggregate of the evaluation scores at the previous stages and a conversation level score. The conversation level score numerically evaluates the chatbot's understanding of the user query and answer correctness. For example, the conversation level score may be 9, given that the client was satisfied with the answer. The overall chat score is generated to numerically evaluate the overall effectiveness of the chatbot's ability to communicate with the user. As an example, the overall score may be given by combining 8, 9, 7, and 9, and results in an overall score of 33.

The chatbot evaluation module 235 provides several technical advantages over other evaluation methods. By evaluating intermediate steps taken by the chatbot, the chatbot evaluation module 235 quickly and precisely identifies the root cause of problems, makes targeted improvements to the chatbot application, and improves the overall effectiveness of the chatbot. For instance, if the relevance score for retrieved documents is consistently low for certain types of user queries, it indicates a potential lack of appropriate help articles to address those queries. This can prompt creation of new help articles to fill these gaps. As another example, if the relevance score for a specific API is consistently low for certain types of user queries, it may indicate a potential lack of appropriate model parameters to accurately call an API.

For the sake of illustration, the following is an example of a conversation evaluated by the chatbot evaluation module 235:
Chatbot: Hello! I'm a shopping virtual assistant. What can I help you with today?
User: my shopper said he left the groceries at my doorstep but I didn't see anything.
Chatbot: I apologize for the inconvenience but I don't have access to your order information.
User: Representative.
Chatbot: I am helping you connect to a specialist.
   The chatbot evaluation module 235 may generate the following evaluation of the conversation above: “The chatbot is designed to directly access an API to retrieve user order details. However, its response does not seem to reflect this capability. By examining its decision-making process at each conversational turn, we can determine whether the issue lies in not invoking the API call, the API call returning no data, or the chatbot application disregarding useful information from the API and providing an incorrect answer.”

The machine-learning training module 230 trains machine-learning models used by the online system 140. For example, the machine-learning module 230 may train the item selection model, the availability model, or any of the machine-learning models deployed by the model serving system 150. The online system 140 may use machine-learning models to perform functionalities described herein. Example machine-learning models include regression models, support vector machines, naïve bayes, decision trees, k nearest neighbors, random forest, boosting algorithms, k-means, and hierarchical clustering. The machine-learning models may also include neural networks, such as perceptrons, multilayer perceptrons, convolutional neural networks, recurrent neural networks, sequence-to-sequence models, generative adversarial networks, or transformers.

Each machine-learning model includes a set of parameters. A set of parameters for a machine-learning model are parameters that the machine-learning model uses to process an input. For example, a set of parameters for a linear regression model may include weights that are applied to each input variable in the linear combination that comprises the linear regression model. Similarly, the set of parameters for a neural network may include weights and biases that are applied at each neuron in the neural network. The machine-learning training module 230 generates the set of parameters for a machine-learning model by “training” the machine-learning model. Once trained, the machine learning model uses the set of parameters to transform inputs into outputs.

The machine learning training module 230 trains a machine-learning model based on a set of training examples. Each training example includes input data to which the machine learning model is applied to generate an output. For example, each training example may include customer data, picker data, item data, or order data. In some cases, the training examples also include a label which represents an expected output of the machine-learning model. In these cases, the machine-learning model is trained by comparing its output from input data of a training example to the label for the training example.

The machine-learning training module 230 may apply an iterative process to train a machine learning model whereby the machine learning training module 230 trains the machine learning model on each of the set of training examples. To train a machine-learning model based on a training example, the machine-learning training module 230 applies the machine learning model to the input data in the training example to generate an output. The machine-learning training module 230 scores the output from the machine-learning model using a loss function. A loss function is a function that generates a score for the output of the machine-learning model such that the score is higher when the machine learning model performs poorly and lower when the machine-learning model performs well. In cases where the training example includes a label, the loss function is also based on the label for the training example. Some example loss functions include the mean square error function, the mean absolute error, hinge loss function, and the cross entropy loss function. The machine learning training module 230 updates the set of parameters for the machine-learning model based on the score generated by the loss function. For example, the machine-learning training module 230 may apply gradient descent to update the set of parameters.

The data store 240 stores data used by the online system 140. For example, the data store 240 stores customer data, item data, order data, and picker data for use by the online system 140. The data store 240 also stores trained machine-learning models trained by the machine learning training module 230. For example, the data store 240 may store the set of parameters for a trained machine-learning model on one or more non-transitory, computer-readable media. The data store 240 uses computer-readable media to store data, and may use databases to organize the stored data.

With respect to the machine-learning models hosted by the model serving system 150, the machine-learning models may already be trained by a separate entity from the entity responsible for the online system 140. In another embodiment, when the model serving system 150 is included in the online system 140, the machine-learning training module 230 may further train parameters of the machine-learning model based on data specific to the online system 140 stored in the data store 240. As an example, the machine-learning training module 230 may obtain a pre-trained transformer language model and further fine tune the parameters of the transformer model using training data stored in the data store 240. The machine-learning training module 230 may provide the model to the model serving system 150 for deployment.

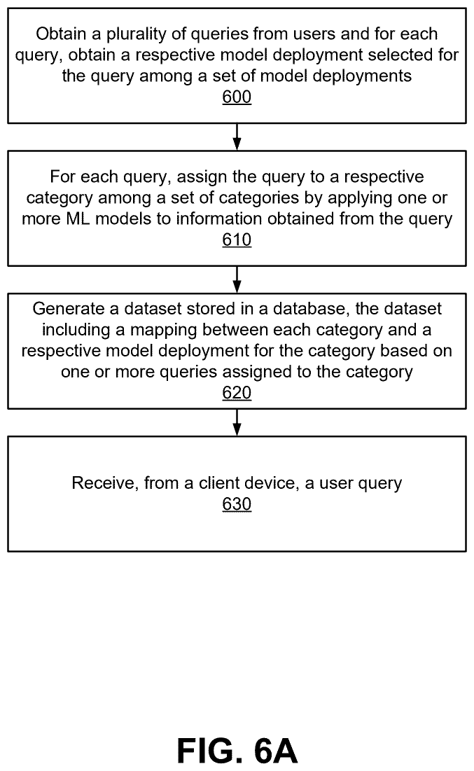

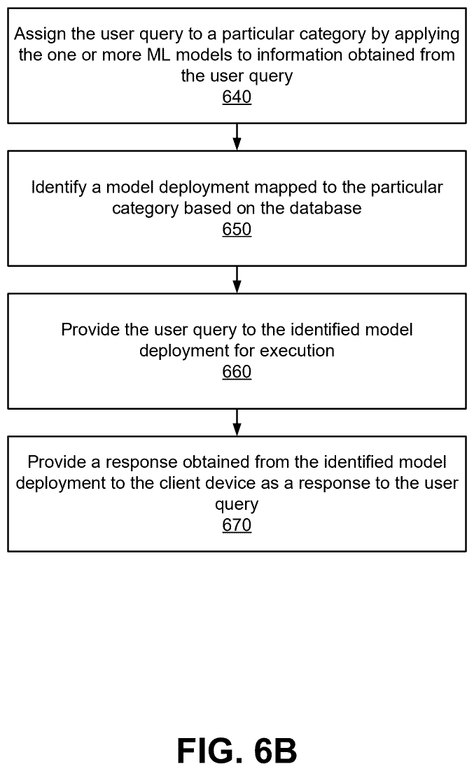

FIGS. 6A-6B is a flowchart illustrating a method of dynamically selecting large-scale model deployments, in accordance with one or more embodiments. Moreover, alternative embodiments may include more, fewer, or different steps from those illustrated in FIGS. 6A-6B, and the steps may be performed in a different order from that illustrated in FIGS. 6A-6B. These steps may be performed by an online system (e.g., online system 140). Additionally, each of these steps may be performed automatically by the online system without human intervention.

The online system 140 obtains 600 a plurality of queries from users and for each query in the plurality of queries, obtains a respective model deployment selected for the query among a set of model deployments. For each query in the plurality of queries, the online system 140 assigns 610 the query to a respective category among a set of categories by applying one or more machine-learning models to information obtained from the query. The online system 140 generates 620 a dataset stored in a database. In one or more embodiments, for each category in the set of categories, the dataset includes a mapping between the category and a respective model deployment for the category based on one or more queries assigned to the category. The online system 140 receives 630, from a client device, a user query. The online system 140 assigns 640 the user query to a particular category of the set of categories by applying the one or more machine-learning models to information obtained from the user query. The online system identifies 650 a model deployment mapped to the particular category from the database. The online system 140 provides 660 the user query to the identified model deployment for execution. The online system 140 provides 670 a response obtained from the identified model deployment to the client device as a response to the user query.

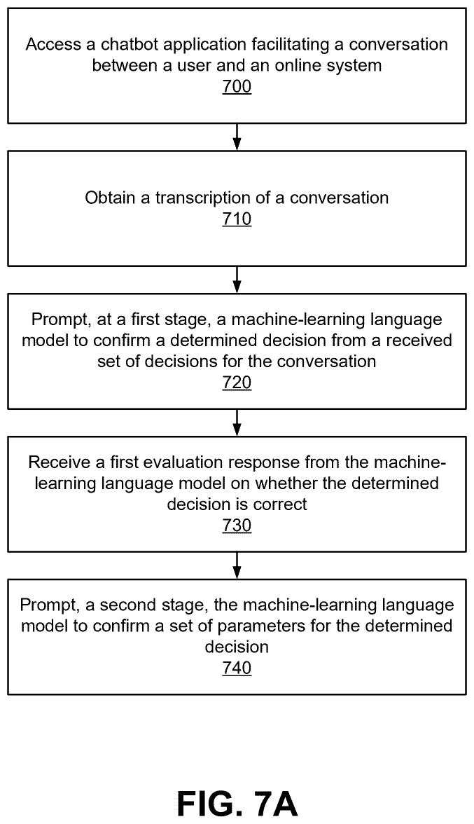

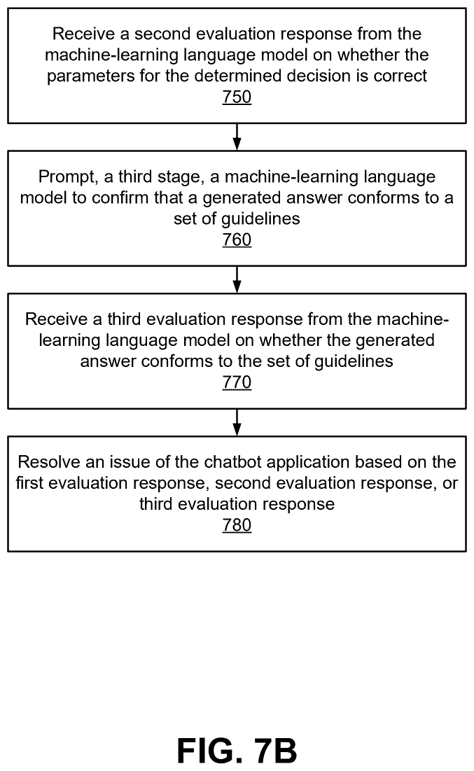

FIGS. 7A-7B is a flowchart illustrating a method of dynamically selecting large-scale model deployments, in accordance with one or more embodiments. Moreover, alternative embodiments may include more, fewer, or different steps from those illustrated in FIGS. 7A-7B, and the steps may be performed in a different order from that illustrated in FIGS. 7A-7B. These steps may be performed by an online system (e.g., online system 140). Additionally, each of these steps may be performed automatically by the online system without human intervention.

The online system 140 accesses 700 a chatbot application that facilitates a conversation between a user and an online system. The online system 140 obtains 710 a transcription of a conversation of the user and the chatbot application. The online system 140 prompts 720, at a first stage, a machine-learning language model to confirm a determined decision from a received set of decisions for the conversation between the user and the chatbot application. The online system 140 receives 730 a first evaluation response from the machine-learning language model on whether the determined decision is correct. The online system prompts 740, at a second stage, the machine-learning language model to confirm a set of parameters for the determined decision. The online system 140 receives 750 a second evaluation response from the machine-learning language model on whether parameters for the determined decision is correct. The online system 140 prompts 760, at a third stage, a machine-learning language model to confirm that a generated answer between the user and the chatbot application conforms to a set of guidelines. The online system 140 receives 770 a third evaluation response from the machine learned language model on whether the generated answer conforms to the set of guidelines. The online system 140 resolves 780 at least an issue of the chatbot application based on the first evaluation response, second evaluation response, or third evaluation response.

### Additional Considerations

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include any embodiment of a computer program product or other data combination described herein.

The description herein may describe processes and systems that use machine learning models in the performance of their described functionalities. A “machine-learning model,” as used herein, comprises one or more machine-learning models that perform the described functionality. Machine learning models may be stored on one or more computer-readable media with a set of weights. These weights are parameters used by the machine learning model to transform input data received by the model into output data. The weights may be generated through a training process, whereby the machine-learning model is trained based on a set of training examples and labels associated with the training examples. The training process may include: applying the machine-learning model to a training example, comparing an output of the machine-learning model to the label associated with the training example, and updating weights associated for the machine-learning model through a back-propagation process. The weights may be stored on one or more computer-readable media, and are used by a system when applying the machine-learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or”. For example, a condition “A or B” is satisfied by any one of the following: A is true (or present) and B is false (or not present), A is false (or not present) and B is true (or present), and both A and B are true (or present). Similarly, a condition “A, B, or C” is satisfied by any combination of A, B, and C being true (or present). As a not-limiting example, the condition “A, B, or C” is satisfied when A and B are true (or present) and C is false (or not present). Similarly, as another not-limiting example, the condition “A, B, or C” is satisfied when A is true (or present) and B and C are false (or not present).

What is claimed is:

1. A computer-implemented method, comprising:
obtaining a plurality of queries from users and for each query in the plurality of queries, obtaining a respective model deployment selected for the query among a set of model deployments;
for each query in the plurality of queries, assigning the query to a respective category among a set of categories by applying one or more machine-learning models to information obtained from the query;
generating a dataset, wherein for each category in the set of categories, the dataset includes a mapping between the category and a respective model deployment for the category identified based on one or more queries assigned to the category, wherein the dataset is stored in a database;
receiving, from a client device, a user query;
assigning the user query to a particular category of the set of categories by applying the one or more machine-learning models to information obtained from the user query;
identifying a model deployment mapped to the particular category from the database;
providing the user query to the identified model deployment for execution; and
providing a response obtained from the identified model deployment to the client device as a response to the user query.

2. The computer-implemented method of claim 1, wherein for each query, assigning the query to the respective category further comprises:
applying a machine-learning embedding model to the query to generate a query embedding;
applying the machine-learning embedding model to the set of categories to generate a set of category embeddings; and
assigning the query to the respective category having a corresponding category embedding below a threshold distance from the query embedding.

3. The computer-implemented method of claim 1, further comprising:
for a query in the plurality of queries, obtaining a set of responses from the set of model deployments generated by executing the query;
transmitting instructions to another client device to cause display of the set of responses and a request to select a preferred response to the query;
obtaining a selection of the preferred response; and
associating a particular model deployment that generated the preferred response as the selected model deployment for the query.

4. The computer-implemented method of claim 1, further comprising:
obtaining a training dataset including a plurality of training examples, a training example indicating a previous query and a label indicating a known category of the previous query;
applying parameters of the one or more machine-learning models to the previous queries of the training examples to generate estimated outputs;
generating a loss function indicating a difference between the estimated outputs and the known labels; and
backpropagating the parameters of the one or more machine-learning models to reduce the loss function.

5. The computer-implemented method of claim 1, further comprising:
for each category in the set of categories, obtaining model deployments associated with the one or more queries assigned to the category;
identifying a particular model deployment selected for a threshold number or proportion of the one or more queries; and
mapping the particular model deployment as the selected model deployment for the category.

6. The computer-implemented method of claim 1, further comprising:
receiving an indication of positive feedback from a user associated with the user query;
generating a training dataset including the user query and the particular category assigned to the user query; and
fine-tuning parameters of the one or more machine-learning models based on the training dataset.

7. The computer-implemented method of claim 1, further comprising:
iteratively refining the set of categories to generate a refined set of categories with a higher degree of granularity; and
updating the dataset to incorporate updated mappings for the refined set of categories and the set of model deployments.

8. A non-transitory computer-readable medium storing instructions that, when executed by one or more computer processors, cause the one or more computer processors to perform operations comprising:
obtaining a plurality of queries from users and for each query in the plurality of queries, obtaining a respective model deployment selected for the query among a set of model deployments;
for each query in the plurality of queries, assigning the query to a respective category among a set of categories by applying one or more machine-learning models to information obtained from the query;
generating a dataset, wherein for each category in the set of categories, the dataset includes a mapping between the category and a respective model deployment for the category identified based on one or more queries assigned to the category, wherein the dataset is stored in a database;
receiving, from a client device, a user query;
assigning the user query to a particular category of the set of categories by applying the one or more machine-learning models to information obtained from the user query;
identifying a model deployment mapped to the particular category from the database;
providing the user query to the identified model deployment for execution; and
providing a response obtained from the identified model deployment to the client device as a response to the user query.

9. The non-transitory computer-readable medium of claim 8, wherein for each query, the operations of assigning the query to the respective category further comprises:
applying a machine-learning embedding model to the query to generate a query embedding;
applying the machine-learning embedding model to the set of categories to generate a set of category embeddings; and
assigning the query to the respective category having a corresponding category embedding below a threshold distance from the query embedding.

10. The non-transitory computer-readable medium of claim 8, the operations further comprising:
for a query in the plurality of queries, obtaining a set of responses from the set of model deployments generated by executing the query;
transmitting instructions to another client device to cause display of the set of responses and a request to select a preferred response to the query;
obtaining a selection of the preferred response; and
associating a particular model deployment that generated the preferred response as the selected model deployment for the query.

11. The non-transitory computer-readable medium of claim 8, the operations further comprising:
obtaining a training dataset including a plurality of training examples, a training example indicating a previous query and a label indicating a known category of the previous query;
applying parameters of the one or more machine-learning models to the previous queries of the training examples to generate estimated outputs;
generating a loss function indicating a difference between the estimated outputs and the known labels; and
backpropagating the parameters of the one or more machine-learning models to reduce the loss function.

12. The non-transitory computer-readable medium of claim 8, the operations further comprising:
for each category in the set of categories, obtaining model deployments associated with the one or more queries assigned to the category;
identifying a particular model deployment selected for a threshold number or proportion of the one or more queries; and
mapping the particular model deployment as the selected model deployment for the category.

13. The non-transitory computer-readable medium of claim 8, the operations further comprising:
receiving an indication of positive feedback from a user associated with the user query;
generating a training dataset including the user query and the particular category assigned to the user query; and
fine-tuning parameters of the one or more machine-learning models based on the training dataset.

14. The non-transitory computer-readable medium of claim 8, the operations further comprising:
iteratively refining the set of categories to generate a refined set of categories with a higher degree of granularity; and
updating the dataset to incorporate updated mappings for the refined set of categories and the set of model deployments.

15. A computer system, comprising:
one or more computer processors; and
a non-transitory computer-readable medium storing instructions that, when executed by one or more computer processors, cause the one or more computer processors to perform operations comprising:
obtaining a plurality of queries from users and for each query in the plurality of queries, obtaining a respective model deployment selected for the query among a set of model deployments;
for each query in the plurality of queries, assigning the query to a respective category among a set of categories by applying one or more machine-learning models to information obtained from the query;
generating a dataset, wherein for each category in the set of categories, the dataset includes a mapping between the category and a respective model deployment for the category identified based on one or more queries assigned to the category, wherein the dataset is stored in a database;
receiving, from a client device, a user query;
assigning the user query to a particular category of the set of categories by applying the one or more machine-learning models to information obtained from the user query;
identifying a model deployment mapped to the particular category from the database;
providing the user query to the identified model deployment for execution; and
providing a response obtained from the identified model deployment to the client device as a response to the user query.

16. The computer system of claim 15, wherein for each query, the operations of assigning the query to the respective category further comprises:
applying a machine-learning embedding model to the query to generate a query embedding;
applying the machine-learning embedding model to the set of categories to generate a set of category embeddings; and
assigning the query to the respective category having a corresponding category embedding below a threshold distance from the query embedding.

17. The computer system of claim 15, the operations further comprising:
for a query in the plurality of queries, obtaining a set of responses from the set of model deployments generated by executing the query;
transmitting instructions to another client device to cause display of the set of responses and a request to select a preferred response to the query;
obtaining a selection of the preferred response; and
associating a particular model deployment that generated the preferred response as the selected model deployment for the query.

18. The computer system of claim 15, the operations further comprising:
obtaining a training dataset including a plurality of training examples, a training example indicating a previous query and a label indicating a known category of the previous query;
applying parameters of the one or more machine-learning models to the previous queries of the training examples to generate estimated outputs;
generating a loss function indicating a difference between the estimated outputs and the known labels; and
backpropagating the parameters of the one or more machine-learning models to reduce the loss function.

19. The computer system of claim 15, the operations further comprising:
for each category in the set of categories, obtaining model deployments associated with the one or more queries assigned to the category;
identifying a particular model deployment selected for a threshold number or proportion of the one or more queries; and
mapping the particular model deployment as the selected model deployment for the category.

20. The computer system of claim 15, the operations further comprising:
receiving an indication of positive feedback from a user associated with the user query;
generating a training dataset including the user query and the particular category assigned to the user query; and
fine-tuning parameters of the one or more machine-learning models based on the training dataset.
